(19) United States
(12) Patent Application Publication
(10) Pub. No.: US 2017/0025259 A1
(43) Pub. Date: Jan. 26, 2017

(54) ULTRAVIOLET LIGHT DETECTION

(71) Applicant: The University of Warwick, Coventry, Warwickshire (GB)

(72) Inventors: Yorck Ramachers, Coventry (GB); Gavin Bell, Coventry (GB)

(21) Appl. No.: 15/301,269

(22) PCT Filed: Mar. 30, 2015
(86) PCT No.: PCT/GB2015/050966

§ 371 Date: Sep. 30, 2016

(30) Foreign Application Priority Data
Apr. 2, 2014 (GB) 1405931.5

(51) Int. Cl. H01J 43/18; H01J 47/02; G01J 1/42

(52) U.S. Cl. CPC H01J 43/18; G01J 1/429; H01J 47/02

(57) ABSTRACT

A device (1), such as a detector or imaging device, for detecting ultraviolet light, is described. The device comprises a housing (4) for a chamber. Disposed within the housing is a charge carrier multiplier structure (9) comprising a dielectric sheet (10) having first and second opposite faces (11, 12) and having an array of holes (16) traversing the dielectric sheet between the first and second faces. The device includes a photocathode (13) supported on the first face of the dielectric sheet, having a work function of less than 6 eV. The device includes an anode (14) supported on the second face of the dielectric sheet.

### FIELD OF THE INVENTION

The present invention relates to a device, such as a detector or imaging device, for detecting ultraviolet light.

### BACKGROUND

Gaseous electron multipliers are known and reference is made to R. Chechik and A. Breskin: “Advances in gaseous photomultipliers”, Nuclear Instruments and Methods in Physics Research A, volume 595, pages 116 to 127 (2008) and A. Breskin et al.: “A concise review on THGEM detectors”, Nuclear Instruments and Methods in Physics Research A, volume 598, pages 107 to 111 (2009).

R. Chechik and A. Breskin: “Advances in gaseous photomultipliers” ibid. describes a gaseous electron multiplier which is sensitive to ultraviolet (UV) radiation. However, the photomultiplier has a cut-off frequency of 210 nm and so is limited to detecting radiation in the extreme UV range.

### SUMMARY

According to a first aspect of the present invention there is provided a device comprising a housing for a chamber and a charge carrier multiplier structure disposed within the housing. The charge carrier multiplier structure comprises a dielectric sheet having first and second opposite faces and having an array of holes traversing the sheet between the first and second faces, a photocathode, supported on the first face of the dielectric sheet, having a work function of less than 6 eV, and an anode supported on the second face of the dielectric sheet.

Thus, the device is able to detect radiation at longer wavelengths in the middle UV range (200-300 nm) and/or at wavelengths in the near UV range (300-400 nm).

The photocathode may have a work function of less than or equal to 50.0 eV, of less than or equal to 4.5 eV, less than or equal to 3.5 eV, less than or equal to 30.0 eV or less than or equal to 2.5 eV. The photocathode may have a work function of at least 2 eV or of at least 3 eV.

The work function is measurable by contact potential difference measurement. For example, a Kelvin probe is used.

The photocathode may include a layer of amorphous semiconductor. The semiconductor may be silicon (Si). For example, amorphous silicon has a work function of 4.7 eV resulting in a cut-off wavelength of 260 nm. The semiconductor may be germanium (Ge).

The photocathode may include a layer of an oxide semiconductor. The oxide semiconductor material may be zinc oxide (ZnO). Zinc oxide has a work function of 3.7 eV resulting in a cut-off wavelength of 335 nm. The oxide semiconductor may be indium oxide (In₂O₃).

The photocathode may include a layer of a metal oxide. The metal oxide may be barium oxide (BaO). The metal oxide may be magnesium oxide (MgO). The metal oxide may be indium tin oxide (“ITO”). Indium tin oxide has a work function of 4.4 eV resulting in a cut-off wavelength of 280 nm. The metal oxide may be aluminium oxide (AlOₓ). Aluminium oxide has a work function of 4.3 eV resulting in a cut-off wavelength of 290 nm.

The amorphous semiconductor layer, oxide layer or metal oxide may have a thickness of at least 10 nm. The amorphous semiconductor layer, oxide layer or metal oxide may have a thickness no more than least 100 nm.

The photocathode may include a layer of surface-modifying material which reduces the work function of an underlying layer, such as an amorphous semiconductor layer, an oxide semiconductor layer, a metal oxide layer or metal layer. The surface-modifying material may also induce an electric dipole at the surface of the underlying layer. The surface-modifying material may be a polymer. The surface-modifying material may be a polymer containing aliphatic amine groups. The surface-modifying material may be polyethylenimine (PEI). A layer of copper coated with polyethylenimine (Cu/PEI) has a work function of 30.6 eV resulting in a cut-off wavelength of 345 nm. A layer of amorphous silicon coated with polyethylenimine (a-Si/PEI) has a work function of 40.0 eV resulting in a cut-off wavelength of 310 nm. A layer of aluminium oxide coated with polyethylenimine (AlOₓ/PET) has a work function of 3.5 eV resulting in a cut-off wavelength of 355 nm. A layer of amorphous zinc oxide coated with polyethylenimine (ZnO/PEI) has a work function of 30.2 eV resulting in a cut-off wavelength of 390 nm.

The photocathode may include a layer of metal. The metal may be a transition metal such as copper, or a noble metal, such as platinum. The photocathode may include a metal bi-layer or metal multi-layer. For example, a metal bi-layer may include a thick base layer comprising a first metal, such as copper or other transition metal, and an over layer of a second, different metal, such as platinum or other transition or noble metal.

The photocathode may comprise a stack of layers. For example, a metal layer, bi-layer or multilayer may form a base for other layers, such as an amorphous semiconductor layer or an oxide semiconductor layer, and/or a surface-modifying layer.

The device may further comprise gas in the housing. The gas may be at atmospheric pressure or at a pressure between 1 Torr (130 Pa) and atmospheric pressure. The gas may comprise a noble gas, for example, argon.

The dielectric sheet may have a thickness of at least 0.4 mm and, optionally, at least 1 mm. The holes traversing the dielectric sheet may have a width or diameter of at least 0.2 mm and, optionally, at least 1 mm. The holes may have an aspect ratio (length divided by width) of between 0.25 and 4 and, optionally, between 0.5 and 2.

The housing may include a window configured to allow transmission of ultraviolet radiation onto the photocathode.

The device is preferably responsive to electromagnetic radiation in a wavelength range of 250 to 400 nm.

The charge carrier multiplier structure may be a first charge carrier multiplier structure and the device may further comprise a second charge carrier multiplier structure disposed between the first charge carrier structure and a window. The second charge carrier multiplier structure comprises a dielectric sheet having first and second opposite faces and having an array of holes traversing the dielectric sheet between the first and second faces, a photocathode, supported on the first face of the dielectric sheet, having a work function of less than 6 eV, and an anode supported on the second face. The device is configured to allow transmission of ultraviolet radiation through the window onto the photocathode of the second charge carrier multiplier structure.

This can be used to provide a more sensitive UV light detector.

The device may comprise three or more charge carrier multiplier structures, i.e. three or more stages.

The device may comprise a camera (e.g. a digital camera) arranged to image the charge carrier multiplier. The camera is preferably responsive to radiation in the optical part of the electromagnetic spectrum.

Thus, the device can be used to capture UV light images.

According to a second aspect of the present invention there is provided apparatus comprising the device and an external power source configured to apply a bias between the photocathode and the anode.

According to a third aspect of the present invention there is provided a method of operating the apparatus, the method comprising applying a potential difference so as to generate an electric field within the holes and exposing the device to UV radiation.

The potential difference may result in an electric field having a value between 0.5 MVm⁻¹ and 2 MVm⁻¹.

### BRIEF DESCRIPTION OF THE DRAWINGS

Certain embodiments of the present invention will now be described, by way of example, with reference to the accompanying drawings, in which:

FIG. 1 is a cross sectional view of a first device for detecting ultraviolet light;

FIG. 1a is a plan view of a photocathode and charge carrier multiplier included in the device shown in FIG. 1;

FIG. 2 is a cross sectional view of a second device for detecting ultraviolet light; and

FIG. 3 is a cross section view of third device for capturing an ultraviolet image.

### DETAILED DESCRIPTION OF CERTAIN EMBODIMENTS

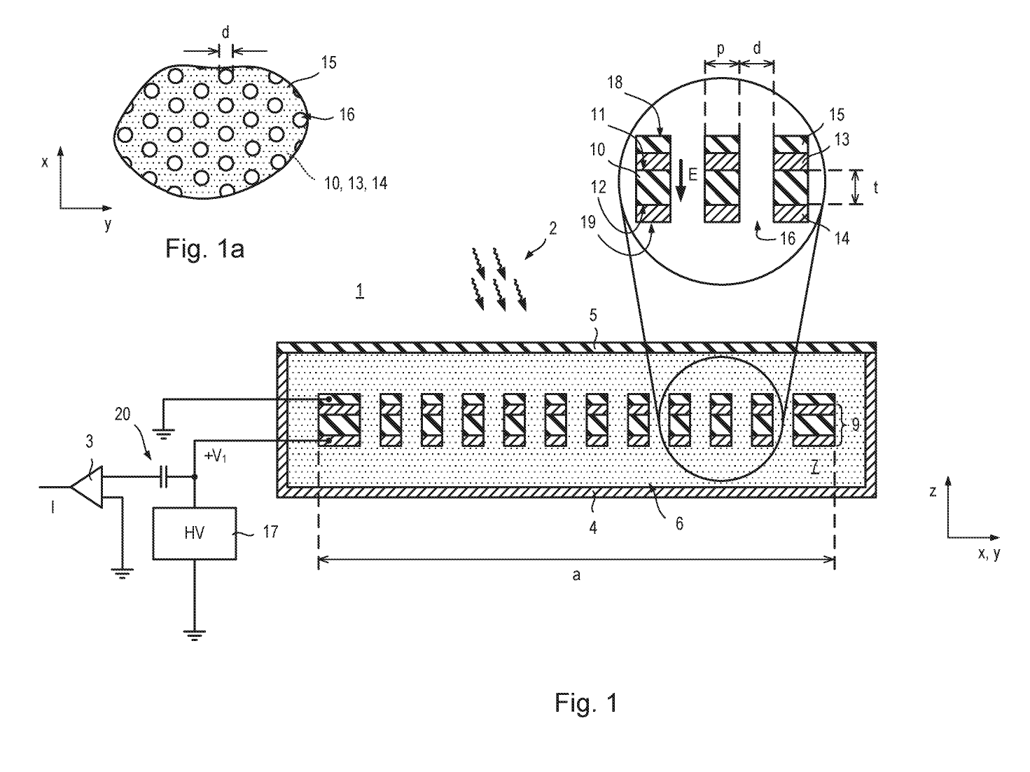

Referring to FIG. 1, a first device 1 in accordance with the present invention is shown. The device 1 is sensitive photons 2 in the ultraviolet part of the electromagnetic spectrum (generally up to a wavelength between about 250 nm to 400 nm) and generates a current which is detected using a current meter 3.

The device 1 is provided with a multi-part housing 4, 5 including a non-gas permeable enclosure part 4, for example, formed from steel or other suitable metal or metal alloy, and a transparent, non-gas permeable window part 5, for example, formed from glass, plastic or other UV transmissive material, which defines a gas-tight sealed chamber 6 and which is filled with an ionisable gas 7. The housing parts 4, 5 may be joined using suitable seals (not shown). In this example, the ionisable gas 7 comprises argon. However, another suitable gas, for example another noble gas, or a mixture of gases can be used. A non-noble, inert gas, such as nitrogen (N₂), may be used. The gas 7 may include a mixture of methane (CH₄) and carbon dioxide (CO₂). The gas 7 is preferably at atmospheric pressure, which is about 760 Torr (101,000 Pa). However, the gas can be at a lower pressure, for example, between about 760 Torr (101,000 Pa) and about 100 Torr (13,000 Pa), between about 100 Torr (13,000 Pa) and 100 Torr (1,300 Pa) or between about 100 Torr (1,300 Pa) and about 1 Torr (130 Pa). The gas and pressure may be chosen so as to reduce backscattering of electrons due to the Ramsauer effect.

The device 1 includes a charge generation and separation arrangement which comprises a charge carrier multiplier 9 in the form of a thick gaseous electron multiplier (THGEM).

The multiplier 9 takes the form of a perforated sandwich structure which comprises a dielectric sheet 10 having first and second opposite faces 11, 12 (hereinafter referred to as front and back faces respectively) which support first and second electrodes 13, 14 respectively. Herein the first electrode 13 and the second electrode 14 are also referred herein as the “photocathode” and “anode” respectively. The second electrode 14 can be used to measure current and so the second electrode 14 can also referred to as the “pick-up” electrode. However, as will be explained later, current need not be measured.

The photocathode 13 may be formed from a layer of amorphous semiconductor, such as amorphous silicon (a-Si). The photocathode 13 may be formed from a layer of an oxide semiconductor, such as zinc oxide (ZnO) or indium oxide (In₂O₃). The photocathode 13 may be formed from a metal oxide such as barium oxide (BaO), magnesium oxide (MgO), indium tin oxide (ITO) or aluminium oxide (AlOₓ). The photocathode 13 may be formed from a layer of metal, such as copper or other transition metal, provided it is coated with a work-function reducing layer. The work function of the photocathode 13 is characterised using contact potential difference measurement. In this case, a Kelvin probe is used, in particular, a GB050 Kelvin Probe (not shown) available from KP Technology Ltd., Burn Street, Wick, UK. Measurements are carried out in a glove box (not shown) under inert conditions with mV resolution, high stability, high noise rejection.

The anode 14 may be formed from copper. However, another transition metal or other suitable conductive material may be used. The electrodes 13, 14 may comprise two or more layers of different material.

Reference is made to “Thick GEM-like hole multipliers: properties and possible applications” by R. Chechnik, A. Breskin, C. Shalem, D. Moermann, Nuclear Instruments and Methods in Physics Research, pages 303 to 308, A535 (2004), R. Chechik and A. Breskin: “Advances in gaseous photomultipliers”, Nuclear Instruments and Methods in Physics Research A, volume 595, pages 116 to 127 (2008) and A. Breskin et al.: “A concise review on THGEM detectors”, Nuclear Instruments and Methods in Physics Research A, volume 598, pages 107 to 111 (2009) which are incorporated herein by reference. A layer of surface-modifying material which reduces the work function of an underlying layer may be used, such as an amorphous semiconductor layer, an oxide semiconductor layer, a metal oxide layer or metal layer. The surface-modifying material may be a polymer. The surface-modifying material may be a polymer containing aliphatic amine groups. The surface-modifying material may be polyethylenimine (PEI). A layer of copper coated with polyethylenimine (Cu/PEI) has a work function of 3.6 eV resulting in a cut-off wavelength of 345 nm.

The photocathode 13 may be coated with a layer 15 of surface-modifying material, such as polyethylenimine (PEI), which reduces the work function of an underlying layer 13. The layer 15 is co-extensive with the underlying photocathode 13 and sheet 10. The work function of the photocathode is preferably as low as possible. The layer 15 may have a thickness of the order of magnitude of 10 nm or 100 nm. However, ultra-thin layers of material, e.g. having a thickness of only one or a few monolayers or having a magnitude of the order of 1 nm can be used which may promote surface or interface effects which may reduce the work function even more. Suitable dielectric materials and metals can be found, for example, in “Work function changes induced by deposition of ultrathin dielectric films on metals: A theoretical analysis” by S. Prada, U. Martinez, and G. Pacchioni, Physical Review B, volume 78, page 235423 (2008) and Y. Zhou et al.: “A universal Method to Produce Low-Work Function Electrodes for Organic Electronic”, Science, volume 336, pages 327 to 332 (2012) in which is incorporated herein by reference.

The photoelectric effect, i.e. light-to-charge conversion, takes place in the photocathode material. Thus, UV photons 2 pass through the window 5 and strike the photocathode 13, thereby generating a mobile electron (not shown) which escapes the material and a bound hole (not shown) in the material.

As shown in FIG. 1, a plurality of through holes 16 traverse the sandwich structure and provide channels through which photo-generated charge carriers (not shown) can travel, collide and generate other charge carriers and so generate an avalanche current. The photocathode 13 is grounded and the anode 14 is biased positively with respect to the photocathode 13. A bias, V₁, is applied by an external high voltage source 17 which applies a bias of about 1 kV to generate an electric field, E, within the holes 16 of about 1 MVm⁻¹.

In this example, the multiplier 9 comprises a single-sided, copper-clad printed-circuit board (PCB) having a thickness, t, of about 1.6 mm and through which holes 16 have been drilled with a diameter, d, of about 1 mm and pitch, p, of about 1 mm in a hexagonal arrangement, as shown in FIG. 1a. The photocathode 13 may be deposited by a physical vapour deposition (PVD) process such as evaporation of material under a vacuum. A double-sided, copper-clad printed-circuit board may be used, i.e. the photocathode 13 may comprise copper. If used, the surface-modifying material may be deposited using solution-processing techniques, such as spin coating and, if required, curing. Thus, the layer 15 is substantially co-extensive with the electrode 13 and, thus, also forms a perforated layer.

The multiplier 9 is generally rectangular (in plan view) and has a width, a, of at least 0.01 m. The multiplier 9 can be larger and can have a width, a, of at least 1 m.

The multiplier 9 is thicker and has larger holes than gaseous electron multipliers commonly used in imaging, such as that described in U.S. Pat. No. 6,011,265 A which is incorporated herein by reference, and which typically use thin (i.e. <0.1 mm) Kapton™ foil. Moreover, the multiplier 9 does not employ a drift field and so there is no drift electrode in front of photocathode 13. Thus, the space in front of the first photocathode 13 is substantially free of an electric field (i.e. E=0).

The multiplier 9 takes care of the charge separation in a similar way to a p-n junction in a semiconductor solar cell by providing a static electric field which separates an electron from its corresponding hole in the cathode. Thus, a current can flow.

Photons 2 approach from a first side (or “front”) 18 of the carrier multiplier structure 9 and strike the photocathode 13. As soon as an electron-hole pair has been created due to the photoelectric effect, the mobile electron (not shown) is removed from its origin due to the strong electrostatic field (not shown) near the holes 16. The electron (not shown) accelerates away from the cathode towards the opposite side 19 (or “back”) of the multiplier 9.

Current is measured using a current sensor 3 in the form of an operational amplifier, although other forms of current measurement can be used. A decoupling capacitor 20 is placed in line between the anode 14 and the current sensor 3.

The use of an ionisable gas 7 allows a sizeable charge avalanche gain to be produced in the gas. A gain of 10,000 can be achieved. Thus, for every photon reaching the cathode, it is possible to harvest several charges.

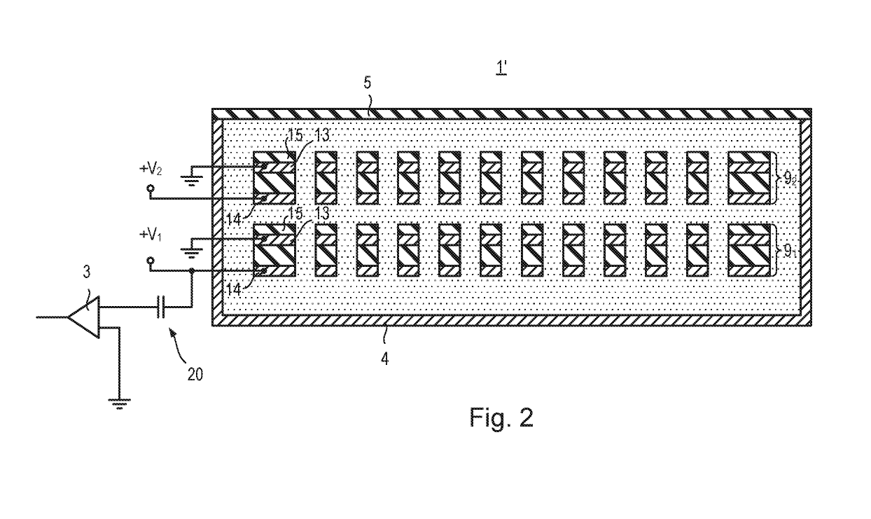

Referring to FIG. 2, a second detector 1′ in accordance with the present invention is shown.

The second detector 1′ is similar to the first detector 1 (FIG. 1) except that detector 1 may include more than one multiplier 9₁, 9₂ arranged in stages to provide greater sensitivity. In this example, there are two multipliers, namely first and second multipliers 9₁, 9₂. The first multiplier 9₁ is interposed between the window 5 and the second multiplier 9₂.

A bias, V₂, is applied to the anode 14 of the second multiplier 9₂. This can be achieved using the voltage source 17 and a potential divider (not shown) comprising ladder of first and second resistors (not shown). Alternatively, another external voltage source (not shown) can be provided and used.

Incident UV light 2 reaches the second multiplier 9₂ first, i.e. the second multiplier 9₂ provides a first stage. The second multiplier 9₂, in addition to generating of an electron-hole pair and causing charge avalanche, generates UV light (not shown) of longer wavelength than the incident UV light 2. The generated UV light (not shown) reaches the first multiplier 9₁, i.e. the second stage, which in turn generates a new electron-hole pair and causes further charge avalanche.

This configuration achieves higher charge multiplication gain and, hence, increases light detection sensitivity for low-intensity UV light detection.

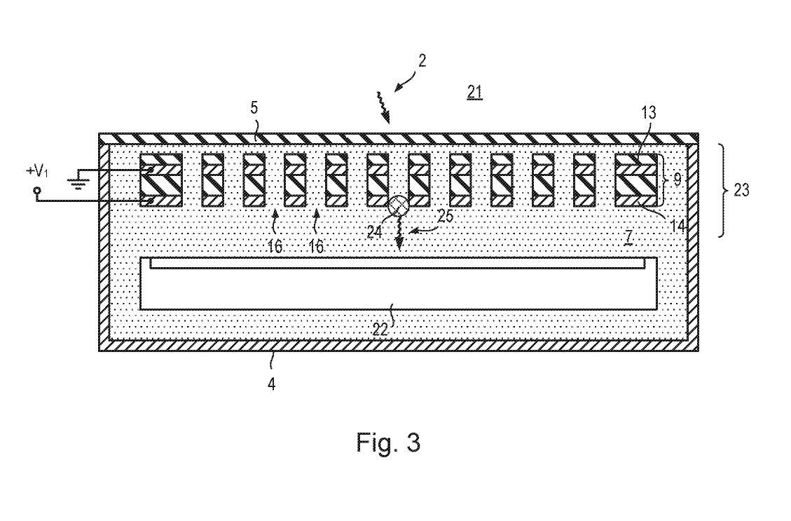

Referring to FIG. 3, a UV imaging device 21 in accordance with the present invention is shown.

The device 21 is similar to the first detector 1 (FIG. 1) except that a visible-light digital camera 22 is mounted beneath the multiplier 9 at an optically suitable distance. The camera uses the multiplier 9 as the imaging plane.

The upper part of the device 23 serves as a UV-to-visible light converter. This is enabled by choosing a gas 7 which fluoresces or emits light through any other mechanism.

Taking the example of argon, a region 24 of the gas 7 emits light 25 in the red and infra-red portion of the spectrum when excited by charge multiplication in the holes 16 (FIG. 1) of the upper part of the device 23. This emission can be captured by the digital camera 22 to produce a UV light image, converted to red light.

Imaging quality is limited by hole 16 granularity. Thus, the pitch and size of the holes can be adjusted according to application.

It will be appreciated that many modifications may be made to the embodiments hereinbefore described. The power supply may be arranged to generate an electric field in the holes between about 0.6 and 1.5 MVm⁻¹. In some examples, the holes may be wider in the electrodes than the dielectric sheet. The device may be provided with ports and valves for filling the chamber with gas and then sealing it. The device may comprise a multi-walled chamber. The holes may be arranged in a different way, for example, in a rectangular array, a quasi array or even randomly. The PCB may comprise FR4, a suitable ceramic material or a suitable plastic, such as PTFE. The device may comprise more than two stages, for example, three, four or five stages. The uppermost stage is arranged to receive ultraviolet radiation through the window.

1. A device comprising:
a housing for a chamber; and
a charge carrier multiplier structure disposed within the housing;
the charge carrier multiplier comprising a dielectric sheet having first and second opposite faces and having an array of holes traversing the dielectric sheet between the first and second faces, a photocathode, supported on the first face of the dielectric sheet, having a work function of less than 6 eV and an anode supported on the second face of the dielectric sheet.

2. A device according to claim 1, wherein the photocathode has a work function of less than or equal to 5.0 eV, of less than or equal to 4.5 eV, less than or equal to 4 eV, less than or equal to 3.5 eV, less than or equal to 3 eV or less than or equal to 2.5 eV.

3. A device according to claim 1, wherein the photocathode includes a layer of amorphous semiconductor and, optionally, the semiconductor is silicon.

4. A device according to claim 1, wherein the photocathode includes a layer of an oxide semiconductor.

5. A device according to claim 4, wherein the oxide semiconductor is zinc oxide or indium oxide.

6. A device according to claim 1, wherein the photocathode includes a layer of a metal oxide.

7. A device according to claim 3, wherein the layer has a thickness less than or equal to 100 nm or less than or equal to 10 nm.

8. A device according to claim 1, wherein the photocathode includes a layer of surface-modifying material which reduces the work function of an underlying layer.

9. A device according to claim 8, wherein the surface-modifying material is a polymer.

10. A device according to claim 9, wherein the polymer is a polymer containing aliphatic amine groups.

11. A device according to claim 9, wherein the polymer is polyethylenimine.

12. A device according to claim 8, wherein the underlying layer is an amorphous semiconductor layer, an oxide semiconductor layer or a metal oxide layer.

13. A device according to claim 8, wherein the underlying layer is a layer of metal.

14. A device according to claim 13, wherein the metal comprises a transition metal, optionally, a noble metal.

15. A device according to claim 8, wherein the underlying layer is a bi-layer which comprises a base layer comprising a first metal and an over layer comprising a second different metal.

16. A device according to claim 1, further comprising:
gas within the housing.

17. A device according to claim 16, wherein the gas is at atmospheric pressure.

18. A device according to claim 16, wherein the gas is at a pressure between 1 Torr and atmospheric pressure.

19. A device according to claim 16, wherein the gas comprises a noble gas, for example, argon.

20. A device according to claim 1, wherein the dielectric sheet has a thickness of between 0.4 mm and 1 mm.

21. A device according to claim 1, wherein the holes traversing the dielectric sheet have a width or diameter of between 0.2 mm and 1 mm.

22. A device according to claim 1, wherein the housing includes a window, wherein the device is configured to allow transmission of ultraviolet radiation through the window onto the photocathode.

23. A device according to claim 1, responsive to electromagnetic radiation in a wavelength range of 250 to 400 nm.

24. A device according to claim 1, wherein the charge carrier multiplier structure is a first charge carrier multiplier structure and the device further comprises:
a second charge carrier multiplier structure disposed in the housing;
the second charge carrier multiplier structure comprising a dielectric sheet having first and second opposite faces and having an array of holes traversing the dielectric sheet between the first and second faces, a photocathode, supported on the first face of the dielectric sheet, having a work function of less than 6 eV, and an anode supported on the second face.

25. A device according to claim 1, further comprising:
a camera arranged to image the charge carrier multiplier.

26. An apparatus comprising:
a device according to claim 1; and
an external power source configured to apply a potential difference between the photocathode and the anode of the charge carrier multiplier.

27. Apparatus according to claim 26, wherein the external power source is configured to provide an electric field within the holes between about 0.5 MVm−1 and about 2 MVm−1.

28. A method of operating the apparatus according to claim 26, the method comprising:
applying a potential difference so as to generate an electric field within the holes of the charge carrier multiplier structure; and
exposing the device to UV radiation.

29. A method according to claim 28, wherein the potential difference results in an electric field having a value between 0.5 MVm−1 and 2 MVm−1.
